(19) United States
(12) Patent Application Publication
(10) Pub. No.: US 2004/0159028 A1
(43) Pub. Date: Aug. 19, 2004

(54) Information engraved on metalic tags adhered to the external surfaces of shoes

(76) Inventor: Jose Luis Muguerza, San Jose, CA (US)

Correspondence Address: Jose Luis Muguerza, 1699 English Dr., San Jose, CA, 95129, US

(21) Appl. No.: 10/365,656

(22) Filed: Feb. 13, 2003

(51) Int. Cl. G09F 23/00

(52) U.S. Cl. 40/636

(57) ABSTRACT

A personal identification tag engraved or printed with information such as emergency contact numbers or bearer's name and address which may be molded to the contour of clothing such as the heel of a shoe and adhered to the exterior, typically the rear exterior portion of the shoe or the heel section.

### BACKGROUND OF INVENTION

1. The invention is based on the construction of a permanently marked identification plate which will withstand abuse from the environment.

2. Description of Prior Tags

a. Identification tags are commonly used to identify children and adults with medical problems such as diabetes, allergies etc.

b. The attachment of identification tags to extremities such as wrists, ankles or necks are extremely common. However, the attachment is usually by means of a chain in contact with the wearer's skin. The chain and tag must be made from components which will not corrode, rust of have an adverse reaction to the wearer's skin. Therefore, the metals chosen are predominantly silver or gold and stainless steel, making them expensive.

c. The wearer of these identification tags with chains introduces a safety hazard. Extraneous surfaces which can catch machinery or exposed surfaces can cause sever damage to the wearer.

d. Children routinely “forget” to wear identification jewelry but usually remember to wear their shoes when they go out.

e. Some approaches to the identification issue have been;

i. Microdots attached to the wearer's teeth. The main problem is that special equipment is required to read this information and it is usually not readily available.

ii. Tags attached to articles of clothing. Such as tags attached to the shoe through the use of shoe laces. This makes the tag clearly visible and aesthetically unacceptable to many children. Also, many kids shoe styles use other kinds of fasteners instead of laces.

iii. These partially solve the safety issue but there remains an aesthetic concern, an availability of fasteners issue and a wear and tear concern with the type of metal.

f. A solution to this problem was contained in U.S. Pat. Nos. 4,858,957, 4,863,195, 4,955,150 and 5,312,136. Each solution required the placement of a notational strip within the shoe and covering the strip with a sheet of plastic. The continuing problem is the information is contained within the shoe and not easily seen and therefore found in case of an emergency.

g. Other solutions contained in U.S. Pat. Nos. D 356,599, D 404,770, 4,254,566, 4,327,512, 4,955,150, 5,195,783, and 6,434,870. These solutions involve attaching something to the shoe laces of the shoe. This option provides a solution but is usually unacceptable to due to high visibility of the information and cumbersome nature of the designs. This new design provides a more user friendly system in which the information is easily accessible without being cumbersome, is functional with any shoe style. Also it does not attract attention or is just plain bothersome when walking. As in the case of U.S. Pat. No. 4,327,512 which involves attaching a container to the shoe laces, then place a strip of paper inside the container with the vital information.

h. Another solution is contained in U.S. Pat. No. 5,367,795. This solution involves a new design for a shoe which includes “windows” to place identification or vital information into. This option provides a solution but is usually unacceptable to due to high visibility of the information windows and to some users the aesthetics of the shoe may be unacceptable. Within this proposal, we are not postulating a new shoe design, simply modifying the currently worn shoe to assist in case of an emergency.

i. Another solution is contained in U.S. Pat. No. 4,610,102. This solution involves adhering a Velcro base with a “cut out pocket” onto the shoe and placing a Velcro/plastic cover over it, therefore producing a “water tight” enclosure. Vital information can then be written onto a tag and placed into the pocket. Our proposed invention is smaller (measuring about 2×0.75 inches) and easily fits on the back of the shoe (heel) or the back of the sole (under the heel). The tag is engraved and is impermeable therefore exposure to moisture would be inconsequential. This factor provides applicability in underwater applications.

There has long been a need to help a lost or injured person/child in an emergency without compromising the person's identity. Typically adults have identification on their person but there is a group of people who routinely do not carry identification. Primarily, children, and some disabled individuals don't have ID's to carry or just plain forget them. This invention provides a discreet way of communicating information such as emergency contact numbers or critical medical information without compromising their everyday security by overtly displaying confidential information.

By using a thin metal base such as anodized aluminum, the wearer can mold the identification plate to an external area of the shoe where they feel comfortable the information will be safe, unobtrusive, easily accessible and clearly seen when sought after.

Further, it is desired that the tag information be protected against wear and contamination. The information is engraved below the surface therefore making the information difficult to be removed. The surface of the metal plate needs to be ground off in order to remove the vital information.

It is desirable that the information tag be attached to an easily accessible article of clothing and not to the person. People and specifically children and the elderly are more likely to consistently wear shoes then jewelry.

### SUMMARY OF THE INVENTION

It is our intention to provide a tag with permanent, unchangeable information which cannot be easily altered. The tag, when engraved with vital information could function as an identification device by adhering it to the exterior of the shoe, typically in the back portion or heel, above or on the sole shall be able to withstand environmental and wearer abuse.

Another object is to provide a malleable tag which can be molded, applied and conforms to the contours of the target object. Even areas such as the back of the shoe where the many styles and designs of shoes provide unending angles and contours.

Another object of this invention is to provide vital information when needed, but not noticeably impact the performance of the target such as a shoe. This is done by using light weight materials coated (when needed) to withstand environmental and user abuse.

Another object of this invention is to provide a tag that has been specially cleaned and in some cases treated for improved adhesion properties between unlike substrates.

Another object is to provide emergency contacts and/or vital information worn daily and available even if the wearer is unconscious.

Another object is to provide the ability to enhance the visibility of the plate by surrounding the perimeter of the plate with reflective tape. Thereby creating a night time, high visibility product.

The above objects are achieved by providing a thin but robust plate (preferably aluminum either anodized or not, but could be made from other substances like pliable plastics and metals) which becomes an engraved tag with a cleaned surface to promote adhesion to unlike substrates.

In the preferred embodiment, one flat surface of an aluminum tag is hard anodized, sealed, and engraved. The plate is then adhered to the back of a shoe using the other large surface which has been treated (cleaned and/or “chemically converted” according to Military Specification Mil-Spec-C-5541E) to promote adhesion.

The tag is of a size and shape to accommodate notations and to fit within the desired target area. If the tag is filled out with vital information, and attached to the back or heel of a shoe allows quick access to the information contained therein in case of emergency.

The placement of the tag on the shoe solves the potential hazards which could occur with the traditional chain attached tags.

With the tag containing vital information, on the back of the shoe, it is accessible, easily found, and yet the individuals privacy is protected from inadvertent exposure to the public. In case the user want added safety features, a reflective tape may be added to the perimeter of the plate thereby substantially increasing visibility.

Further, the tag installation as described (adhered to the back of the shoe) provides an area which protects the tag from dislodging as compared to other more active shoe areas such as shoe lace's.

The selection of the shoe as the mounting place for the vital information is optimal as usually, one wears shoes when going out, and is not usually forgotten or misplaced, as the chain mounted tags might be.

### DESCRIPTION OF THE TAG

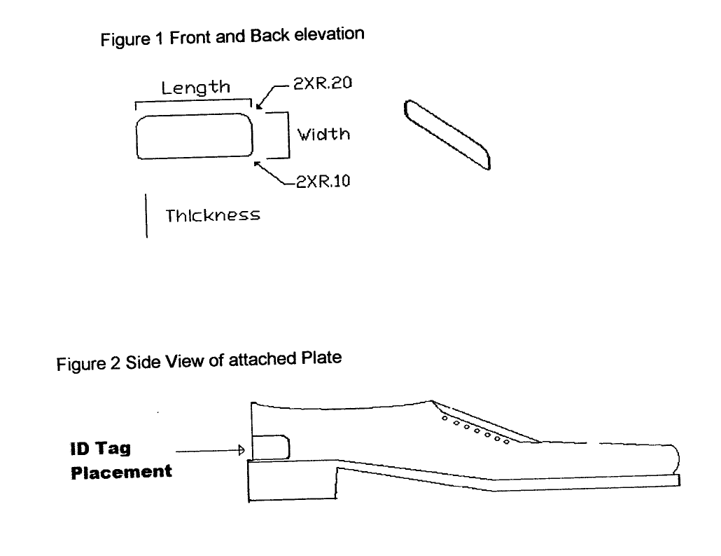

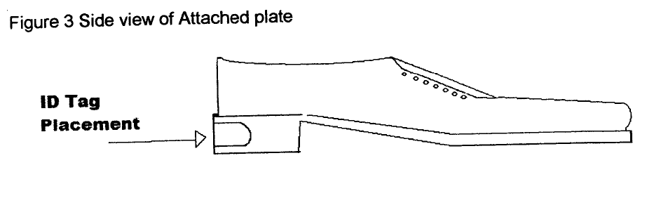

The above and other embodiments of the present invention may be better understood from the following detailed description, taken together with the attached drawing (FIG. 1).

A semi-rigid (malleable) plate made from a variety of materials including some plastics and metals.

FIG. 1

All the dimensions are in inches.

The plate is:

Length of plate is 1.50 to 3.0 inches

Width of plate is 0.625 to 1.0 inches

Thickness of the plate is 0.01 to 0.1 inch.

With rounded corners.

This provides an adequate area to engrave vital information and yet be small enough to be unobtrusive and functional.

### DESCRIPTION OF THE PREFERRED EMBODIMENT

Generally, as a first step, all metal tags begin as a lightly grained metal sheet, which undergoes a thorough cleaning, to promote good substrate adhesion.

Next, one surface (the one which is to be adhered onto the shoe) is covered with non residue tape. This protects the surface from becoming dirty before the plate is adhered onto the target such as a shoe's back.

Other processing:

Aluminum—After the cleaning process, the plate undergoes a chemical conversion process (Military Specification Mil-C-5541E), one face is covered with tape (with non residue silicon adhesive) to protect the surface's newly applied chemical conversion.

Next, the plate is Hard Anodized (and may be dyed in different colors), and sealed. The Aluminum plate is then cut to the required size and shape as illustrated in FIG. 1.

Other metals and semi rigid plastics—After the cleaning process, the plate is ready to be engraved.

Once the plates are prepared, the next step is to engrave the necessary information by way of a rotary or laser engraver. Next, the plate is ready to be adhered to the target.

Adhesion onto a target such as a shoe is accomplished by way of several different adhesives including petroleum distillates and silicon derivatives. The adhesives are spread onto the desired area of adhesion and to the plate. They are left to cure momentarily, and then both surfaces are joined together and pressed for a few seconds. The surfaces are then left to dry for approximately 24 hours. This will permanently adhere the engraved plate onto the target substrate.

1. An improved identification tag arrangement comprised of;
A thin plate, the exterior side is permanently marked or engraved with the desired information. This eliminates the likelihood of the information becoming difficult to read or illegible due to partial or complete erasure of the information due to solvents or the exterior of the plate being deformed.
The exterior surface is hard coated (in the case of aluminum) to provide a “tougher” exterior.

2. The interior side (or part that is to be adhered) is treated (cleaned or
Chemically converted as per Military Specification C-5541D in the case of aluminum) and covered (prevention of contamination) for optimum adhesion between different composition substrates.
The adhesive used is specially selected for optimal performance in the climate for which it is intended (i.e. extreme cold, high humidity etc).

3. The malleable nature of the identification tag together with the inherent
Enduring qualities of hard anodizing the exterior provide an identification system which can be molded and adhered to any of the external surfaces of a shoe.

4. This identification tag can be used as a basis for communicating vital
Information and when augmented with a reflective tape strip surrounding the perimeter of the plate, it becomes a superior highly visible communication system.
